(19) United States
(12) Patent Application Publication
(10) Pub. No.: US 2019/0273791 A1
(43) Pub. Date: Sep. 5, 2019

(54) METHOD AND SYSTEM FOR PROCESSING APPLICATION PROGRAM NOTIFICATION OF MOBILE TERMINAL, AND MOBILE TERMINAL

(71) Applicant: HuiZhou TCL Mobiie Communication Co., Ltd., HuiZhou (CN)

(72) Inventors: Ke FENG, HuiZhou (CN); Yajun HU, HuiZhou (IL); Qundian CHEN, HuiZhou (IL)

(73) Assignee: HuiZhou TCL Mobiie Communication Co., Ltd., HuiZhou (CN)

(21) Appl. No.: 16/346,881

(22) PCT Filed: Oct. 24, 2017
(86) PCT No.: PCT/CN2017/107528

§ 371 Date: May 2, 2019

(30) Foreign Application Priority Data
Nov. 2, 2016 (CN) 201610945072.2

(51) Int. Cl. H04L 29/08; G06F 3/0481; G06F 9/451

(52) U.S. Cl. CPC H04L 67/26; G06F 9/451; G06F 3/04817

(57) ABSTRACT

A method for processing application program notification of a mobile terminal. The method comprises: acquiring a notification of an application program when the notification is pushed from the application program; determining whether the current display screen of a mobile terminal is the desktop of the mobile terminal, if not, retaining the notification of the application program, no prompt popping up; if yes, displaying a preset floating icon on the desktop of the mobile terminal to carry out the notification prompt.

### BACKGROUND

### 1. Field of the Disclosure

The present disclosure relates to the field of a mobile terminal, and more particularly, to a method of processing notification of an application installed in a mobile terminal, a system of the mobile terminal, and the mobile terminal.

### 2. Description of the Related Art

A mobile terminal refers to a moving computer device. The mobility of a mobile terminal is mainly embodied in mobile communication and portability. Broadly speaking, a mobile terminal includes cellphones, notebooks, point of sales (POS) machines, and even car computers. A user can use a mobile terminal to talk, video-call, take pictures, listen to music, watch videos, and play games. Besides, a mobile terminal can position, process information, scan fingerprints, ID cards, barcodes, RFID, and IC cards, and detect alcohol content. Clearly, a mobile terminal has a lot of functions.

Take a cellphone (a kind of mobile terminals) as an example. More and more applications are installed on a smartphone of the related art. These applications generally send various types of notifications from time to time. However, the user often feels disturbed when using the smartphone. More than necessary notifications bring great inconvenience to the user. When the consumer uses his/her smartphone to making calls, playing games, or watching videos, prompts will pop up. However, these prompts may affect user experience.

### SUMMARY

The present disclosure proposes a method of processing notification of an application installed in a mobile terminal, a system of the mobile terminal, and the mobile terminal to solve the problem that a mobile terminal of the related art sends more than necessary notifications which causes interference to the users of the mobile terminal.

According to a first aspect of the present disclosure, a method of processing notification of an application installed in a mobile terminal comprises:

obtaining the notification of the application when the application pushes the notification;

determining whether a current display interface of the mobile terminal is a desktop of the mobile terminal; if not, retaining the notification of the application without popping up a prompt; if so, displaying a preset floating icon for notifying the prompt on the desktop of the mobile terminal.

According to one embodiment of the present disclosure, a step of obtaining the notification of the application when the application pushes the notification comprises:

obtaining the notification of the application and a type of the notification of the application when the application pushes the notification.

According to one embodiment of the present disclosure, a step of displaying a preset floating icon for notifying the prompt on the desktop of the mobile terminal comprises:

determining whether the type of the notification is obtained in a first time; if so, displaying the preset floating icon on the desktop of the mobile terminal and prompting a function of the type of the notification; if not, displaying the preset floating icon on the desktop of the mobile terminal.

According to one embodiment of the present disclosure, the preset floating icon is shaped as a floating water drop, and a step of displaying a preset floating icon for notifying the prompt on the desktop of the mobile terminal further comprises:

diffusing the floating water drop and making the floating water drop transparent;

determining whether a command of triggering the floating water drop is received by a predetermined time or not; if so, displaying a rotation of the floating water drop; if not, hiding the floating water drop on the desktop of the mobile terminal.

According to one embodiment of the present disclosure, the step of diffusing and making the floating water drop transparent comprises:

expanding the floating water drop by a predetermined times;

shrinking the expanded floating water drop to an original size;

processing the floating water drop with transparency to make a current floating water drop more transparent than a default transparency.

According to a second aspect of the present disclosure, a system of processing notification of an application installed in a mobile terminal comprises:

one processor or a plurality of processors;

a memory; and

one or more applications, stored in the memory and executed by the processor, the one or more applications comprising:

a notification obtaining module, configured to obtain the notification of the application when the application pushes the notification;

an interface determining module, configured to determine whether a current display interface of the mobile terminal is a desktop interface; if not, a first notification processing module is executed; if so, a second notification processing module is executed;

the first notification processing module, configured to retain the notification of the application without popping up a prompt;

the second notification processing module, configured to display a preset floating icon for notifying the prompt on the desktop of the mobile terminal.

According to one embodiment of the present disclosure, the notification obtaining module comprises a type obtaining module configured to obtain the notification of the application and a type of the notification of the application when the application pushes the notification.

According to one embodiment of the present disclosure, the second processing module comprises a type determining and processing unit configured to determine whether the type of the notification is obtained in a first time, configured to display the preset floating icon on the desktop of the mobile terminal and prompting a function of the type of the notification, and configured to displaying the preset floating icon on the desktop of the mobile terminal when the type of the notification is not obtained in the first time.

According to one embodiment of the present disclosure, the preset floating icon is shaped as a floating water drop, the system further comprises:

a diffusive transparent module, configure to diffuse the floating water drop and make the floating water drop transparent; and

a notification triggering module, configured to determine whether a command of triggering the floating water drop is received by a predetermined time or not, configured to display a rotation of the floating water drop when a command of triggering the floating water drop is received by a predetermined time, and configured to hiding the floating water drop on the desktop of the mobile terminal when the command of triggering the floating water drop is not received by the predetermined time.

According to one embodiment of the present disclosure, the diffusive transparent module comprises: an expanding unit, configured to expand the floating water drop by a predetermined times; a shrinking unit, configured to shrink the expanded floating water drop to an original size; and a transparent processing unit, configured to process the floating water drop with transparency to make a current floating water drop more transparent than a default transparency.

According to a third aspect of the present disclosure, a mobile terminal comprises:

one processor or a plurality of processors;

a memory; and

one or more applications and program instructions, stored in the memory and executed by the processor, wherein the program instructions are executed by the processor to perform operations:

obtaining the notification of the application when the application pushes the notification;

determining whether a current display interface of the mobile terminal is a desktop of the mobile terminal; if not, retaining the notification of the application without popping up a prompt; if so, displaying a preset floating icon for notifying the prompt on the desktop of the mobile terminal, wherein the notification of the application and a type of the notification of the application are obtained when the application pushes the notification, and wherein keeping the prompt until the mobile terminal displays the desktop interface upon a condition that a current display interface of the mobile terminal is not the desktop interface, wherein the prompt is a single prompt.

According to one embodiment of the present disclosure, an operation of displaying a preset floating icon for notifying the prompt on the desktop of the mobile terminal comprises:

determining whether the type of the notification is obtained in a first time; if so, displaying the preset floating icon on the desktop of the mobile terminal and prompting a function of the type of the notification; if not, displaying the preset floating icon on the desktop of the mobile terminal.

According to one embodiment of the present disclosure, the preset floating icon is shaped as a floating water drop, and an operation of displaying a preset floating icon for notifying the prompt on the desktop of the mobile terminal further comprises:

diffusing the floating water drop and making the floating water drop transparent;

determining whether a command of triggering the floating water drop is received by a predetermined time or not; if so, displaying a rotation of the floating water drop; if not, hiding the floating water drop on the desktop of the mobile terminal.

According to one embodiment of the present disclosure, the operation of diffusing and making the floating water drop transparent comprises: expanding the floating water drop by a predetermined times; shrinking the expanded floating water drop to an original size; processing the floating water drop with transparency to make a current floating water drop more transparent than a default transparency.

Compared with the related art, notification of an application is obtained after the application sends a notifying push message according to the method of processing notification of an application installed in a mobile terminal and a system of the mobile terminal proposed by the present disclosure. Whether a current display interface of the mobile terminal is the desktop of the mobile terminal is determined. If not, the notification of the application is retained without popping out any prompts. If so, a preset floating icon as a notification prompt is displayed on the desktop of the mobile terminal. In this way, the problem that too many notifications from the mobile terminal of the related art disturb a cellphone's user easily are effectively improved, thereby bringing great convenience to the user.

### BRIEF DESCRIPTION OF THE DRAWINGS

FIG. 1 illustrates a flowchart of a method of processing notification of an application installed in a mobile terminal according to a first embodiment of the present disclosure.

FIG. 2 illustrates a flowchart of a method of processing notification of an application installed in a mobile terminal according to another embodiment of the present disclosure.

FIG. 3 illustrates a block diagram of a system of processing notification of an application installed in a mobile terminal according to another embodiment of the present disclosure.

FIG. 4 illustrates a schematic diagram of a system of processing notification of an application installed in a mobile terminal according to another embodiment of the present disclosure.

### DETAILED DESCRIPTION OF THE EMBODIMENTS

For the purpose of description rather than limitation, the following provides such specific details as a specific a method and a system of processing notification of an application installed in a mobile terminal for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

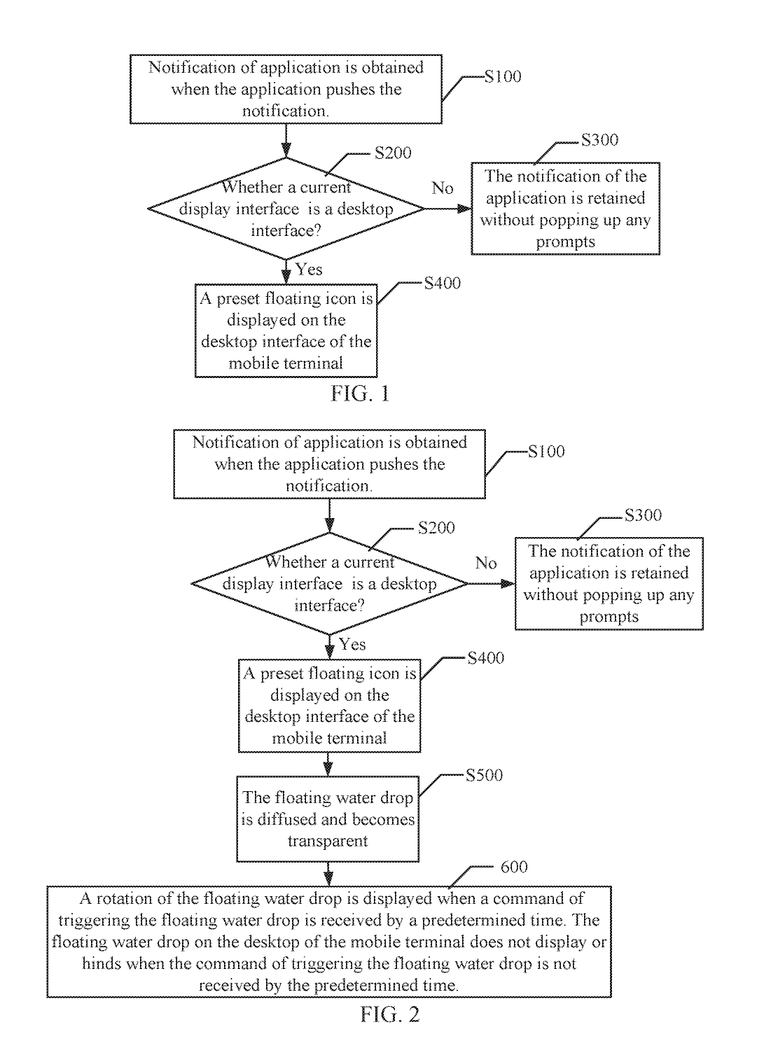

Please refer to FIG. 1 illustrating a flowchart of a method of processing notification of an application installed in a mobile terminal according to a first embodiment of the present disclosure. The method includes block S100, block S200, block S300, and block S400.

At block S100, the notification of the application is obtained when the application pushes the notification.

At block S200, whether a current display interface of the mobile terminal is a desktop of the mobile terminal or not is determined. If not, perform block S300. If so, perform block S400.

At block S300, the notification of the application is retained without popping up any prompts.

At block S400, a preset floating icon is displayed on the desktop interface of the mobile terminal to notify the prompt.

The above blocks are described in detail below in conjunction with specific embodiments.

At block S100, the notification of the application is obtained when the application sends a notification push message. The mobile terminal of the present disclosure may be a mobile terminal, a tablet computer or the like where an application can be installed. In actual application, the notification of the application is obtained when the fact that the application of the mobile terminal sends a notification push message is detected. In block S200, whether the mobile terminal is currently on the desktop is determined. If so, the preset floating icon is displayed on the desktop of the mobile terminal to notify the prompt. If not, the notification of the application is retained without popping out any prompt. That is to say, the current state of the mobile terminal is checked when the fact that the application sends notification. If it is on the desktop, a floating icon is displayed as a notification prompt. If it is not on the desktop (such as a game, video, Internet, etc.), the notification is retained without any prompts. In this way, the notification of the application can prevent from disturbing the user. This prompt appears on the desktop only instead of popping up while the consumer is using the cellphone, such as making a call, playing games, watching videos, etc. Besides, the user will not be disturbed by some notifications with low attention when watching videos or playing games.

Further, block S100 includes block S110.

At block S110, the notification of the application is obtained and a corresponding type is notified when the application notifying that pushing is done.

Specifically, the mobile terminal not only obtains the notification but also receives the type of the notification when the application notifies that the sending is done.

In another embodiment, block S400 includes block S410.

At block S410, whether the type of a current notification is a first prompt or not is determined. If so, display a preset floating icon on the desktop of a mobile terminal to notify a prompt, and the function of prompting the type of notification floats. If not, display the preset floating icon on the desktop of the mobile terminal.

Specifically, a determination is added to the original process, that is, to determine whether the pop-up notification is a first pop-up. If the notification of the type is popped for the first time, not only the preset floating icon is displayed on the mobile terminal but also the function that prompts for this type of notification floats. Regarding the floating prompt function, the effect of the notification type is described, that is, which result is obtained after the user clicks on the notification of the type. If the notification of this type is not popped for the first time, the preset floating icon is displayed on the desktop of the mobile terminal. This is because there are a lot of applications installed in the mobile terminal so there are many types of notifications. For the same type of notification, the first time the type notification is popped up to give the user a prompt. The user will know the method after clicking the notification. The notification will no longer have this prompt.

In actual application, when a certain type of notification needs to be popped up, it is necessary to determine whether it is desktop currently. If it is not desktop, the notification will be retained until the user enters the desktop, and such notification will only pop up one at a time without a plurality of notifications. The problem will only occur after one is processed. When this type of prompt pops out for the first time, a floating interface as a prompt only appears once. This gives the user the convenience of notification processing. In another embodiment, for different types of notifications, different floating icons may be used for corresponding display, which further enables a cellphone's user to view different types of notifications at a glance and deal with them separately.

Please refer to FIG. 2 illustrating a flowchart of a method of processing notification of an application installed in a mobile terminal according to another embodiment of the present disclosure. A floating icon is a floating water drop. Further, block S400 is followed by block S500 and block S600.

At block S500, the floating water drop is diffused and becomes transparent.

At block S600, it is determined that whether a command of triggering the floating water drop is received by a predetermined time or not. A rotation of the floating water drop is displayed when a command of triggering the floating water drop is received by a predetermined time. The floating water drop on the desktop of the mobile terminal does not display or hinds when the command of triggering the floating water drop is not received by the predetermined time.

Specifically, in actual application, the floating icon is a floating water drop. After the preset floating water drop icon is displayed on the desktop of the mobile terminal, the floating water drop is diffused and processed to be transparent. Afterward, whether a trigger command for the floating water drop is received by a predetermined time (that is, whether the user has clicked on the floating water drop) is determined. If so, the notification dynamically rotates and floats as a progress prompt. If not, the floating water drop is not displayed on the desktop of the mobile terminal. The predetermined time may be 30 seconds. Regarding the notification that dynamically rotating and floating as a progress prompt, the floating notification enlarges and rotates in progress, which realizes a dynamic notification prompt in a rotating and floating manner.

Further, block S500 includes block S510, block S520, and block S530.

At block S510, the water drop is expanded to a predetermined multiple of the default water drop.

At block S520, the expanded water drop is shrunk to the size of the default water drop.

At block S530, the water drop is processed with transparency to make the current water drop more transparent compared the water drop with the default transparency.

In actual application, the notification will appear in the form of a floating water drop, including two parts of the animation of diffusion and contraction. After the animation is completed, the notification will be transparent, and the floating water drop can be dragged to any position on the screen. If the user doesn't click on the floating water drop, it will disappear automatically (for example, there is no trigger command within 30 seconds). If the user enables another application, the floating water drop will disappear. If the user clicks on the water drop, there will be a process of dynamic processing that uses the progress of the dynamic rotation, that is, the above dynamic rotation floating progress prompt for the notification. Regarding the predetermined multiple, 1.1 times, 1.2 times, 2 times, etc. is possible according to actual needs. Regarding high transparency, the current drop icon is more transparent than the previous drop icon, such as a 30% increase in transparency.

In another embodiment, a block S300 as introduced above is further followed by a block of giving the retained notification of the application a floating icon to serve as a notification prompt when the current display interface of the mobile terminal is detected to be a desktop. That is to say, the retained notification continues to be a prompt for the user when the cellphone shows the desktop.

The disclosure is described in detail below with reference to the application examples. The disclosure adopts a new notification system, and gives a prompt without affecting the consumer's using the mobile terminal. A floating water drop (including diffusion and transparency) is adopted. Only when the user clicks on the water drop will notification be operated. The notification is accompanied by a dynamically rotating prompt, which only appears on the desktop instead of popping up a prompt when the user is using the cellphone such as making a call, playing games, watching videos, etc. If the user does not operate the mobile terminal, the notification will disappear automatically. After the operation, a dynamic rotating and floating prompt will be shown to the user, which greatly enhances user experience. The merits are pure application implementation, independent of platform and system, simple to implement, and highly portable, so the present disclosure is suitable for all mobile terminals.

When the application sends notification, the service will accept the type of the sent notification and pops out on the desktop and the lightened screen. If the prompt is not saved on the desktop, the prompt will pop up the next time the user switches to the desktop. When the prompt pops up, the cellphone will determine the type of the first popped-up prompt. If it is the first time, the floating prompt will be added to the floating water drop. If it is not the first time, the floating water drop will directly pops up. When the water drop is clicked, the progress of the dynamic rotation will pop up. After the completion, the user can click to enter the corresponding application or click to disappear. After the prompt is displayed, the prompt will not disappear automatically.

In the present disclosure, a brand-new user design is adopted and the default notification form of Android is modified. Such notification will only pop up on the desktop. Other applications will automatically disappear. An animated effect is predetermined on the notification. This kind of do-not-disturb (DND) notification will be realized by the combination of floating water drops and dynamic rotation. It is based on the development of the mobile terminal of the related art. The hardware is not necessary; instead, pure application layer is implemented. Platform modification does not involve, instead; cross-platform and cross-device are probable. These all are advantages of reducing a lot of costs. Different from the default notification form of Android, the design uses the form of popping up a floating water drop on the desktop to prompt the user, which effectively improves the defects of too many notifications and very easy to disturb, effectively improving the drawbacks of Android notifications. So the floating notification can be very good to enhance user's experience.

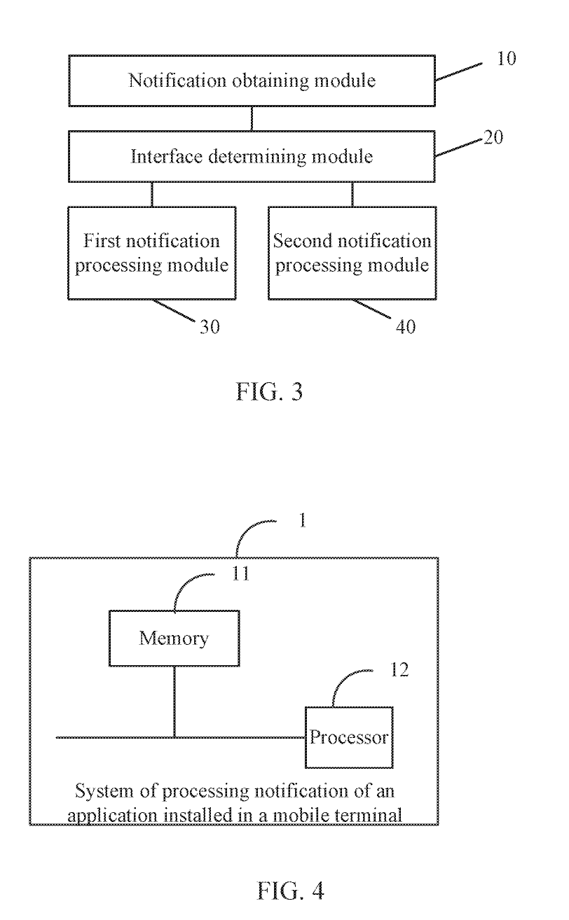

Based on the method of processing notification of the application installed in the mobile terminal proposed by the above embodiment, the present disclosure further provides a system of processing notification of an application installed in a mobile terminal. Please refer to FIG. 3. The system of processing notification of an application installed in a mobile terminal includes a notification obtaining module 10, an interface determining module 20, a first notification processing module 30, and a second notification processing module 40.

The notification obtaining module 10 is configured to obtain a notification of an application when the application pushes the notification.

The interface determining module 20 is configured to determine whether the current display interface of the mobile terminal is a mobile terminal desktop. If not, the first notification processing module 30 is executed. If so, the second notification processing module 40 is executed;

The first notification processing module 30 is configured to keep the notification of the application without popping out the prompt.

The second notification processing module 40 is configured to display the preset floating icon as a notification prompt on the desktop of the mobile terminal.

The notification obtaining module 10 includes a type obtaining module.

The type obtaining module is configured to obtain a notification of the application and a type corresponding to the notification when the application sends a notification push message.

The second processing module 40 includes a type determining and processing unit.

The type determining and processing unit is configured to determine whether the type of the current notification is a first prompt or not. If so, a preset floating icon is displayed on the desktop of the mobile terminal to notify the prompt and the function of prompting the type of notification floats. If not, a preset floating icon is displayed on the desktop of the mobile terminal.

The floating icon is a floating water drop. The application notification processing system further includes a diffusive transparent module and a notification triggering module.

The diffusive transparent module is configured to diffuse the floating water drop and make the floating water drop transparent.

The notification triggering module is configured to determine whether the trigger command towards the floating water drop is received by the predetermined time or not. If so, the notification is prompted in a manner of dynamic rotation and flotation. If not, the floating water drop is not displayed on the desktop of the mobile terminal.

The diffusive transparent module includes an expanding unit, a shrinking unit, and a transparent processing unit.

The expanding unit is configured to enlarge a water drop to a predetermined multiple of a default water drop.

The shrinking unit is configured to reduce the expanded water drop to the default water drop.

The transparent processing unit is configured to process the water drop with transparency to make the current water drop more transparent compared the water drop with the default transparency.

The specific principles and detailed technical features of the application notification processing system of the mobile terminal are described in detail in the embodiment in which the method of processing notification of an application installed in a mobile terminal is elaborated. So the system will not be detailed.

The division of the above functional modules is only for exemplification. In practical applications, the above functional assignments may be performed by different functional modules as needed, that is, divided into different functional modules to complete all or some of the functions described above.

A person skilled in the art can understand that all or some of the processes in the foregoing embodiment can be completed by a computer (or a mobile terminal) program. The program installed in the computer can be stored in a readable storage medium in a computer and may include the process of the methods introduced in the above embodiments when being executed. The storage medium may be a magnetic disc, an optical disc, a read only memory (ROM), or a random access memory (RAM). As illustrated in FIG. 4, in the embodiment of the present disclosure, the system of processing notification of an application installed in a mobile terminal 1 includes a processor 11 and a memory 12. The memory 12 is connected to the processor 11. The program is stored in the memory 12 and is executed by the processor 11.

The present disclosure also proposes a mobile terminal. The mobile terminal includes:

one processor or a plurality of processors;

a memory; and

one or more applications and program instructions, stored in the memory and executed by the processor, wherein the program instructions are executed by the processor to perform operations:

obtaining the notification of the application when the application pushes the notification;

determining whether a current display interface of the mobile terminal is a desktop of the mobile terminal; if not, retaining the notification of the application without popping up a prompt; if so, displaying a preset floating icon for notifying the prompt on the desktop of the mobile terminal, wherein the notification of the application and a type of the notification of the application are obtained when the application pushes the notification, and wherein keeping the prompt until the mobile terminal displays the desktop interface upon a condition that a current display interface of the mobile terminal is not the desktop interface, wherein the prompt is a single prompt.

In some embodiments, an operation of displaying a preset floating icon for notifying the prompt on the desktop of the mobile terminal comprises:

determining whether the type of the notification is obtained in a first time; if so, displaying the preset floating icon on the desktop of the mobile terminal and prompting a function of the type of the notification; if not, displaying the preset floating icon on the desktop of the mobile terminal.

In some embodiments, the preset floating icon is shaped as a floating water drop, and an operation of displaying a preset floating icon for notifying the prompt on the desktop of the mobile terminal further comprises:

diffusing the floating water drop and making the floating water drop transparent;

determining whether a command of triggering the floating water drop is received by a predetermined time or not; if so, displaying a rotation of the floating water drop; if not, hiding the floating water drop on the desktop of the mobile terminal.

In some embodiments, the operation of diffusing and making the floating water drop transparent comprises:

expanding the floating water drop by a predetermined times;

shrinking the expanded floating water drop to an original size;

processing the floating water drop with transparency to make a current floating water drop more transparent than a default transparency.

In summary, a method of processing notification of an application installed in a mobile terminal, a system of the mobile terminal, and the mobile terminal are proposed by the present disclosure. By obtaining the notification of the application when the application pushes the notification, retaining the notification of the application without popping up a prompt if the mobile terminal does not display a desktop interface, and displaying a preset floating icon on the desktop interface of the mobile terminal if the mobile terminal displays the desktop interface, the method, system and mobile terminal according to the present disclosure effectively improve the defect that the mobile terminal of the related art sends the users more than necessary notifications and brings a lot of convenience. This type of DND notification will be implemented by means of a combination of floating water drops and dynamic rotation. Different from Android's default notification form, the present disclosure adopts the form of popping-up floating water drops only on the desktop as a prompt for the user, effectively improving the defects that too many notifications easily disturb the user. Besides, pure implementation of applying layers without platform modification, cross-platform, and cross-device use are probable. It is not necessary to add hardware, which has a great advantage of cost. Therefore, floating notifications can improve the user experience.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A method of processing notification of an application installed in a mobile terminal, comprising:
obtaining the notification of the application when the application pushes the notification;
retaining the notification of the application without popping up a prompt if the mobile terminal does not display a desktop interface; and
displaying a preset floating icon on the desktop interface of the mobile terminal if the mobile terminal displays the desktop interface.

2. The method of claim 1, wherein a step of obtaining the notification of the application when the application pushes the notification comprises:
obtaining the notification of the application and a type of the notification of the application when the application pushes the notification.

3. The method of claim 2, wherein a step of displaying a preset floating icon on the desktop interface of the mobile terminal if the mobile terminal displays the desktop interface comprises:
displaying the preset floating icon on the desktop of the mobile terminal and prompting a function of the type of the notification when the type of the notification is obtained in a first time;
displaying the preset floating icon on the desktop of the mobile terminal when the type of the notification is not obtained in the first time.

4. The method of claim 1, wherein the preset floating icon is shaped as a floating water drop, and a step of displaying the preset floating icon on the desktop interface of the mobile terminal if the mobile terminal displays the desktop interface further comprises:
diffusing the floating water drop and making the floating water drop transparent;
displaying a rotation of the floating water drop when a command of triggering the floating water drop is received by a predetermined time; and
hiding the floating water drop on the desktop of the mobile terminal when the command of triggering the floating water drop is not received by the predetermined time.

5. The method of claim 4, wherein a step of diffusing and making the floating water drop transparent comprises:
expanding the floating water drop by a predetermined times;
shrinking the expanded floating water drop;
processing the floating water drop with transparency to make a current floating water drop more transparent than a default transparency.

6. A system of processing notification of an application installed in a mobile terminal, comprising:
one processor or a plurality of processors;
a memory; and
one or more applications, stored in the memory and executed by the processor, the one or more applications comprising:
a notification obtaining module, configured to obtain the notification of the application when the application pushes the notification;
an interface determining module, configured to determine whether a current display interface of the mobile terminal is a desktop interface;
a first notification processing module, configured to retain the notification of the application without popping up a prompt if the mobile terminal does not display a desktop interface;
a second notification processing module, configured to display a preset floating icon on the desktop interface of the mobile terminal if the mobile terminal displays the desktop interface.

7. The system of claim 6 wherein the notification obtaining module comprises a type obtaining module configured to obtain the notification of the application and a type of the notification of the application when the application pushes the notification.

8. The system of claim 7 wherein the second processing module comprises a type determining and processing unit configured to display the preset floating icon on the desktop of the mobile terminal and prompting a function of the type of the notification when the type of the notification is obtained in a first time, and configured to displaying the preset floating icon on the desktop of the mobile terminal when the type of the notification is not obtained in the first time.

9. The system of claim 6 wherein the preset floating icon is shaped as a floating water drop, the system further comprises:
a diffusive transparent module, configure to diffuse the floating water drop and make the floating water drop transparent; and
a notification triggering module, configured to display a rotation of the floating water drop when a command of triggering the floating water drop is received by a predetermined time, and configured to hiding the floating water drop on the desktop of the mobile terminal when the command of triggering the floating water drop is not received by the predetermined time.

10. The system of claim 6 wherein the diffusive transparent module comprises:
an expanding unit, configured to expand the floating water drop by a predetermined times;
a shrinking unit, configured to shrink the expanded floating water drop; and
a transparent processing unit, configured to process the floating water drop with transparency to make a current floating water drop more transparent than a default transparency.

11. A mobile terminal comprising:
one processor or a plurality of processors;
a memory; and
one or more applications and program instructions, stored in the memory and executed by the processor, wherein the program instructions are executed by the processor to perform operations:
obtaining the notification of the application and a type of the notification of the application when the application pushes the notification;
retaining the notification of the application without popping up a prompt if the mobile terminal does not display a desktop interface; and
displaying a preset floating icon on the desktop interface of the mobile terminal if the mobile terminal displays the desktop interface.

12. The method of claim 11, wherein an operation of displaying a preset floating icon on the desktop interface of the mobile terminal if the mobile terminal displays the desktop interface comprises:
displaying the preset floating icon on the desktop of the mobile terminal and prompting a function of the type of the notification when the type of the notification is obtained in a first time;
displaying the preset floating icon on the desktop of the mobile terminal when the type of the notification is not obtained in the first time.

13. The mobile terminal of claim 11, wherein the preset floating icon is shaped as a floating water drop, and an operation of displaying the preset floating icon on the desktop interface of the mobile terminal if the mobile terminal displays the desktop interface further comprises:
diffusing the floating water drop and making the floating water drop transparent;
displaying a rotation of the floating water drop when a command of triggering the floating water drop is received by a predetermined time; and
hiding the floating water drop on the desktop of the mobile terminal when the command of triggering the floating water drop is not received by the predetermined time.

14. The mobile terminal of claim 13, wherein an operation of diffusing and making the floating water drop transparent comprises:
expanding the floating water drop by a predetermined times;
shrinking the expanded floating water drop;
processing the floating water drop with transparency to make a current floating water drop more transparent than a default transparency.
